(19) United States
(12) Patent Application Publication
(10) Pub. No.: US 2020/0280776 A1
(43) Pub. Date: Sep. 3, 2020

(54) ACOUSTIC DEVICE

(71) Applicant: Onkyo Corporation, Osaka (JP)

(72) Inventors: Shuji OKANO, Tokyo (JP); Shuichi YAMAGAMI, Tokyo (JP)

(21) Appl. No.: 16/797,278

(22) Filed: Feb. 21, 2020

(30) Foreign Application Priority Data
Feb. 28, 2019 (JP) 2019-035523

(51) Int. Cl. H04R 1/02; H04R 5/02

(52) U.S. Cl. CPC H04R 1/025; H04R 5/02; H04R 1/023; H04R 2205/024; H04R 2201/021; H04R 2499/15; H04R 1/028

(57) ABSTRACT

An acoustic device including: a first speaker box that a first speaker unit is arranged; a second speaker box that a second speaker unit is arranged; and an enclosure that the first speaker box and the second speaker box are arranged at an inside, wherein the enclosure has an adjustment part which adjust an interval between the first speaker box and the second speaker box.

### CROSS-REFERENCE TO RELATED APPLICATIONS

This application claims priority to Japanese Application No. 2019-035523, filed Feb. 28, 2019, the entire contents of which are incorporated herein by reference.

### FIELD

The present disclosure relates to an acoustic device.

### BACKGROUND

In an acoustic device which houses speakers of a plurality of channels in one enclosure, there is a so-called bar type acoustic device which is arranged under a television screen so as to be adjacent to the television screen. There are many cases that such a bar type acoustic device is sold separately from a television. For this reason, there is a case where a width of the television and a width of the bar type acoustic device do not match. There is a case where such the state is not preferable on an appearance.

Since there are various television screen sizes, there is a technology to adjust a width of the bar type acoustic device to so as to match a width of the television and a width of the bar type acoustic device. In US2010/0104124A1, an appearance is improved by sliding a position of a speaker box which is mounted on an enclosure of the bar type acoustic device to a longitudinal direction of the enclosure and by matching the width of the bar type acoustic device to the width of the television.

A configuration of a bar type acoustic device (hereinafter, referred to as an “acoustic device”) in US2010/0104124A1 is described with reference to FIG. 11. As illustrated in FIG. 11(a), in a conventional acoustic device 101, a first speaker box 106 that a first speaker unit 108 is arranged and a second speaker box 107 that a second speaker unit 109 is arranged are arranged at an enclosure 102. As illustrated in FIG. 11(b), the first speaker box 106 and the second speaker box 107 can be slidden to a longitudinal direction (X axis direction of FIG. 11) against the enclosure 102 and a width of the longitudinal direction of the acoustic device 101 can be adjusted.

There is a case where a thin type television such as a liquid crystal television or the like is fixed to a wall surface directly. In such the case, it is preferable that the acoustic device 101 is also fixed to the wall surface on an appearance. However, the above mentioned background technology, when fixing the acoustic device 101 to the wall surface by a screw or the like, a place where can be screwed is limited to a part of the enclosure 102. In FIG. 11(c), four corners of the enclosure 102 is fixed to the wall surface by a wall surface fixing screw 120, a wall surface fixing screw 121 and so on.

When the first speaker box 106 and the second speaker box 107 are fixed to the wall surface by screwing and so on directly, a vibration of the speaker boxes is easy to conduct to the wall surface directly. For this reason, there is a case where an unnecessary vibration of the wall surface is easy to occur and this becomes to a noise. Further, there is also a case where a sound of the acoustic device 101 conducts to the wall surface and is easy to leak to an adjacent room. Further, since a necessity to add a mounting metal fitting or the like to the speaker boxes occurs so as to make a structure that the first speaker box 106 and the second speaker box 107 are fixed to the wall surface directly, it is possible to give a bad influence to a sound quality of the acoustic device 101.

For this reason, four corners of the enclosure 102 have to be fixed by using the wall surface fixing screw 120, the wall surface fixing screw 121 and so on so as to fix the acoustic device 101 to the wall surface. For example, the acoustic device 101 has a length of a longitudinal direction (X axis direction) of one (1) meters extent. It is preferable to fix a vicinity of an edge part of the longitudinal direction of the acoustic device 101 so as to mount the acoustic device 101 on the wall surface stably. However, since the edge part of the longitudinal direction of the acoustic device 101 is the speaker box in the conventional acoustic device 101, the edge part cannot be fixed. For this reason, fixing of the wall surface of the acoustic device 101 becomes unstable.

Further, there are many cases where a structure of an inside in a wall surface of a general building is not uniform. For example, a part which has a pillar which can be screwed, a part which does not have a pillar which cannot be screwed, a part which has a concrete pillar which is hart to be screwed and so on exist. For this reason, there is a case where a large restriction for mounting construction occurs with regard to a structure which can be screwed to the wall surface by only a part of the enclosure 102 as the conventional acoustic device 101.

Further, since each of the first speaker box 106 and the second speaker box 107 becomes to a structure which projects from the enclosure 102 to X axis direction, it is necessary to fix to the enclosure 102 firmly. Therefore, the acoustic device 101 comes to be a structure that a vibration of the first speaker box 106 and the second speaker box 107 is easy to conduct to the enclosure 102.

### SUMMARY OF THE DISCLOSURE

According to one aspect of the disclosure, there is provided an acoustic device comprising: a first speaker box that a first speaker unit is arranged; a second speaker box that a second speaker unit is arranged; and an enclosure that the first speaker box and the second speaker box are arranged at an inside, wherein the enclosure has an adjustment part which adjust an interval between the first speaker box and the second speaker box.

### BRIEF DESCRIPTION OF THE DRAWINGS

FIG. 1 is a diagram illustrating an example of an acoustic device according to an embodiment of the present disclosure.

FIG. 2(a)-2(d) is a diagram illustrating an example of an acoustic device according to an embodiment of the present disclosure.

FIG. 3(a)-3(b) is a diagram illustrating an example of an acoustic device according to an embodiment of the present disclosure.

FIG. 4(a)-4(d) is a diagram illustrating an example of an acoustic device according to an embodiment of the present disclosure.

FIG. 5 is a diagram illustrating an example of a hanging part of an acoustic device according to an embodiment of the present disclosure.

FIG. 6 is a block diagram illustrating an example of an acoustic device according to an embodiment of the present disclosure.

FIG. 7(a)-7(b) is a diagram illustrating an example of an acoustic device according to an embodiment of the present disclosure.

FIG. 8(a)-8(c) is a diagram illustrating an example of a state that an acoustic device according to an embodiment of the present disclosure is fixed on a wall surface.

FIG. 9(a)-9(d) is a diagram illustrating an example of an acoustic device according to an embodiment of the present disclosure.

FIG. 10(a)-10(b) is a diagram illustrating an example of an acoustic device according to an embodiment of the present disclosure.

FIG. 11 (a)-11 (c) is a diagram illustrating an appearance of a conventional acoustic device.

### DETAILED DESCRIPTION OF THE PREFERRED EMBODIMENTS

The present disclosure is made by taking into the consideration of the above described problem and a problem of the present disclosure to provide an acoustic device which can adjust a size of a longitudinal direction and be fixed to a wall surface stably.

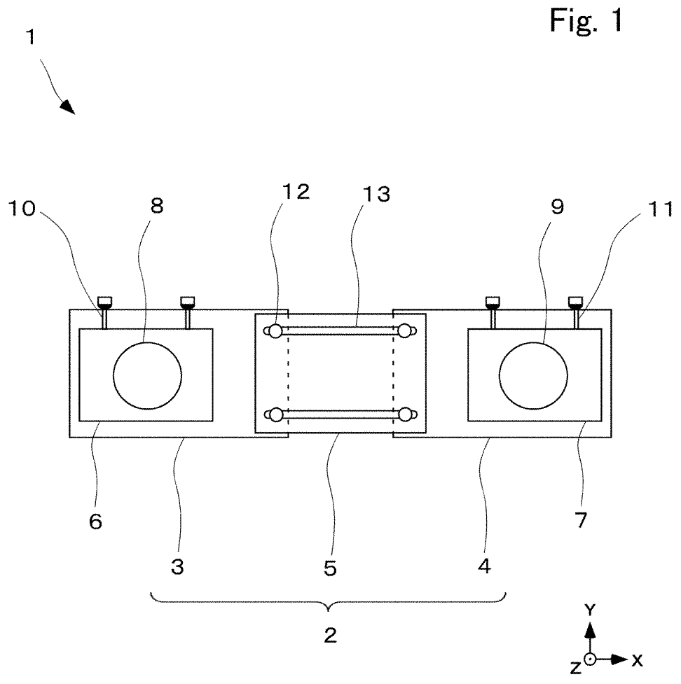

An acoustic device according to an embodiment of the present disclosure is described below. FIG. 1 is a diagram illustrating an appearance of an acoustic device 1 according to an embodiment of the present disclosure and a diagram that the acoustic device 1 is seen from a positive direction of Z axis of FIG. 1 to a negative direction, namely, a diagram which is seen from a listener side. The acoustic device 1 is composed of a first speaker box 6 that a first speaker unit 8 is arranged, a second speaker box 7 that a second speaker unit 9 is arranged, and an enclosure 2 that they are arranged at an inside. The enclosure 2 has a first enclosure 3 that the first speaker box 6 is arranged at an inside and a second enclosure 4 that the second speaker box 7 is arranged at an inside. Further, the enclosure 2 has a third enclosure 5 which connects the first enclosure 3 and the second enclosure 4.

Herein, as a speaker box, the one that a speaker unit is arranged at an enclosure is illustrated. The speaker box becomes to a configuration which can emit a sound of an input signal when inputting a signal. In FIG. 1, while one speaker unit is arranged at one speaker box, not limited to this, speaker units which are not less than two may be arranged.

The first speaker box 6 and the second speaker box 7 respectively become to structures which are hung at the first enclosure 3 and the second enclosure 4 by a first hanging part 10 and a second hanging part 11 (the detail is described below). For this reason, the first enclosure 3 does not contact with the first speaker box 6. Similarly, the second enclosure 4 does not also contact with the second speaker box 7.

The third enclosure 5 has linear shape long holes 13 and the first enclosure 3 and the second enclosure 4 are fixed to the third enclosure 5 by enclosure adjustment screws 12 (The enclosure adjustment screws 12 are respectively inserted into the linear shape long holes 13). By this structure (an adjustment part), fixed positions of the first enclosure 3 and the second enclosure 4 against the third enclosure 5 can be optionally adjusted within a range of a length of the linear shape long hole 13 and a length of a longitudinal direction (X axis direction) of the acoustic device 1 can be adjusted so as to match a width of a television. In FIG. 1, while the first enclosure 3 and the third enclosure 5 are fixed by one enclosure adjustment screw 12 against one linear shape long hole 13, they may be fixed by two enclosure adjustment screws 12, for example. There is a case where can fix more firmly by fixing against one linear shape long hole 13 by a plurality of enclosure adjustment screws 12. Fixing between the second enclosure 4 and the third enclosure 5 is also similar.

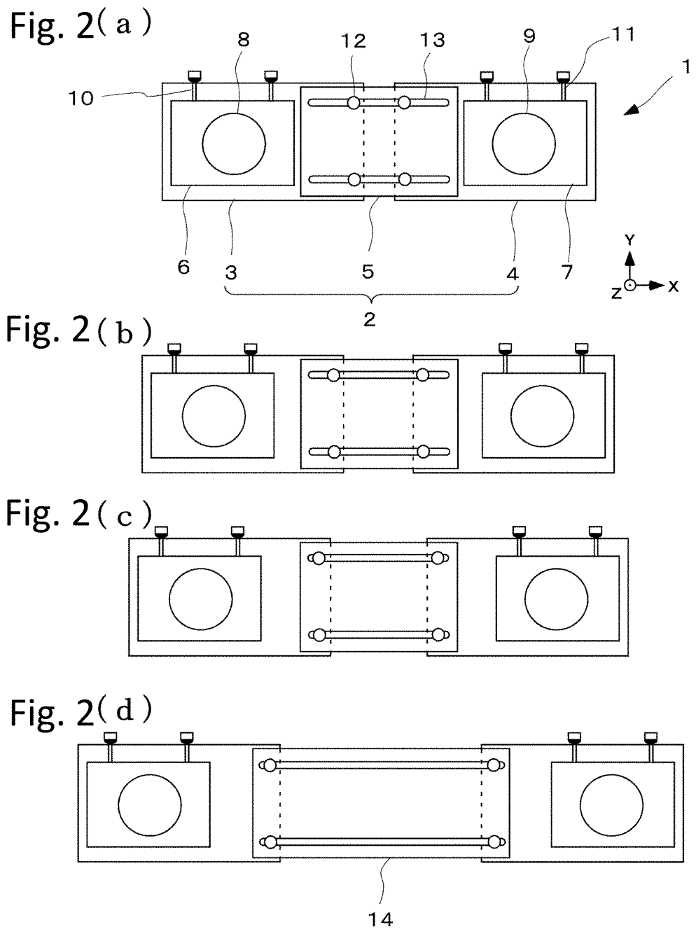

A state that the length of the longitudinal direction (X axis direction) of the acoustic device 1 is adjusted is described by using FIG. 2. As illustrated in FIG. 2 (a), (b), and (c), the length of the longitudinal direction of the acoustic device 1 is adjusted by fixing the first enclosure 3 and the second enclosure 4 at any part of the linear shape long holes 13 by using the enclosure adjustment screws 12. FIG. 2(c) is a state that the length of the longitudinal direction of the acoustic device 1 is adjusted to maximum. When adjusting longer than this, an extension third enclosure 14 which is longer may be used instead of the third enclosure 2. Further, the acoustic device 1 which is longer can be also configured by inserting and fixing another enclosure between the first enclosure 3 and the third enclosure 5. Further, similarly, another enclosure can be inserted and fixed between the second enclosure 4 and the third enclosure 5. Herein, the one which is the same as the first enclosure 3 may be used as another enclosure and a dedicated enclosure for an extension may be used.

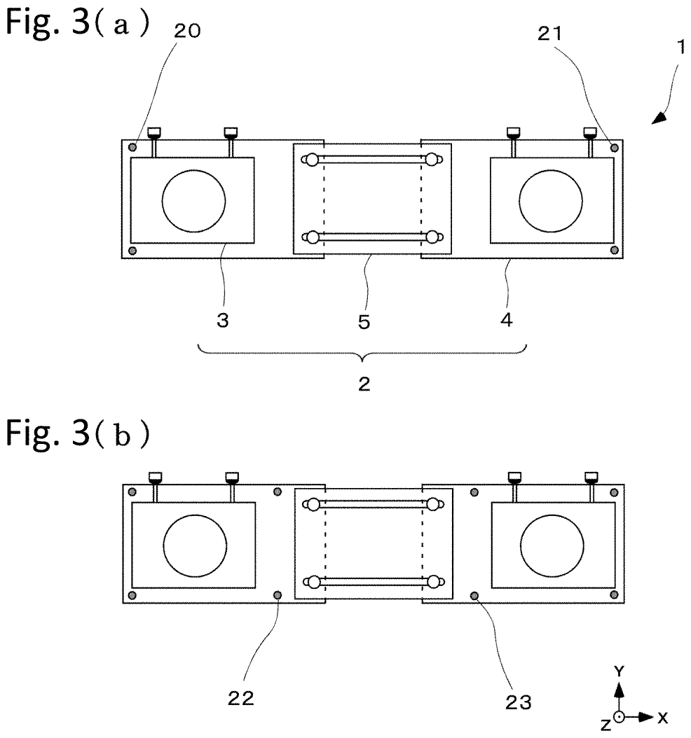

FIG. 3 illustrates an example of a fixed place when fixing the acoustic device 1 to the wall surface. FIG. 3 (a) is an example that the acoustic device 1 is fixed to the wall surface by fixing four corners of an edge part of the longitudinal direction (X axis direction) of the enclosure 2 to the wall surface by using a wall surface fixing screw 20, a wall surface fixing screw 21 and so on. Further, FIG. 3 (b) illustrates a case where four corners of the first enclosure 3 and the second enclosure 4 is fixed to the wall surface by using a wall surface fixing screw 22, a wall surface fixing screw 23 and so on. Further, the other part of the first enclosure 3, the second enclosure 4, and the third enclosure 5 may be fixed to the wall surface. The fixing method may be a method to screw to the wall surface by using a hole (a fixing part) which is opened at the enclosure or a method to fix to the wall surface by mounting a metal fitting on the enclosure 2. According to this, since the acoustic device 1 can be fixed to the wall surface by a near part to an edge surface of the longitudinal direction of the acoustic device 1, it is possible to fix the acoustic device 1 to the wall surface stably. Since any part of the enclosure 2 can be fixed to the wall surface, it is hard that amounting position is restricted by non-uniformity of an inside structure of the wall surface.

Further, since the fixed place is not the speaker box and the enclosure 2, it is hard that a vibration of the speaker box conducts to the wall surface and occurring of a noise by an unnecessary vibration of the wall surface can be suppressed. Further, a sound of the acoustic device 1 can be hard to leak to an adjacent room. Further, it can be suppressed that the wall surface fixing screw 20 and so on gives a bad influence against a sound quality of the speaker box.

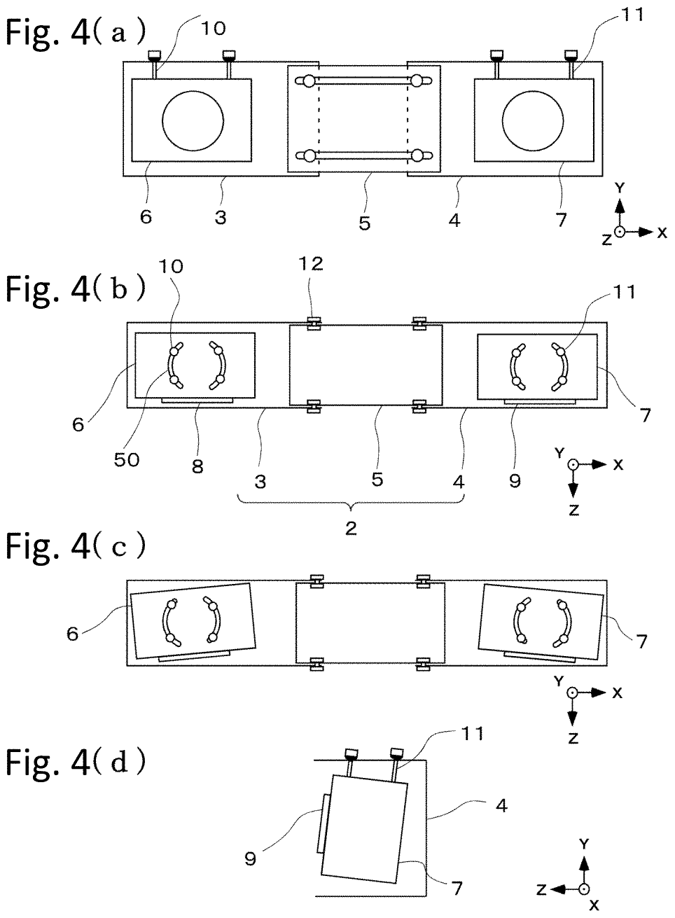

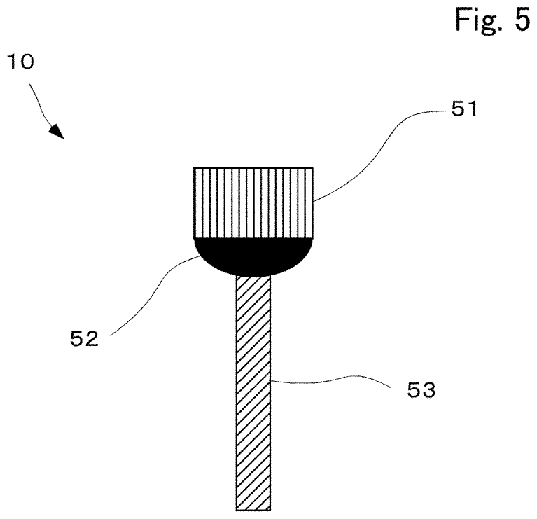

A hanging structure of the speaker box is described by using FIG. 4. As illustrated in FIG. 4(a), the first speaker box 6 and the second speaker box 7 are respectively arranged in a state which is hung at the first enclosure 3 and the second enclosure 4 by a first hanging part 10 and a second hanging part 11, namely, hung. The first hanging part 10 uses a bolt of a shape which is illustrated in FIG. 5. In the bolt of the first hanging part 10, an elastic body 52 such as a rubber or the like is arranged between a bolt head part 51 and a bolt thread part 53. The second hanging part 11 is also similar.

FIG. 4 (b) is a diagram that the acoustic device 1 is seen from a positive direction to a negative direction of Y axis. Arc shape long holes 50 are formed top plate parts (surfaces which are orthogonal to Y axis) of the first enclosure 3 and the second enclosure 4. The first speaker box 6 and the second speaker box 7 are hung by inserting the first hanging part 10 and the second hanging part 11 into the arc shape long holes 50. The first enclosure 3 and the second enclosure 4 contact the elastic bodies 52 of the first hanging part 10 and the second hanging part 11. Thus, since the most of a vibration of the first speaker box 6 and the second speaker box 7 is absorbed by the elastic bodies 52, the vibration becomes hard to conduct to the enclosure 2.

Since the first speaker box 6 and the second speaker box 7 are respectively hung at the arc shape long holes 50 by the first hanging part 10 and the second hanging part 11, a sound emitting direction can be adjusted. Since the length of the longitudinal direction of the acoustic device 1 can be adjusted, there is a case where to set the sound emitting direction of the speaker box to a listener is requested based on an adjustment of the length of the longitudinal direction. As illustrated in FIG. 4(c), the sound emitting direction of the speaker box can be easily adjusted by arranging the first hanging part 10 and the second hanging part 11 at any position of the arc shape long holes 50. An adjustment range of the sound emitting direction may be broadened by chamfering corners of the first speaker box 6 and the second speaker box 7.

FIG. 4 (d) is a diagram that the acoustic device 1 is seen from a positive direction to a negative direction of X axis. The sound emitting direction of the speaker box 7 can be adjusted to an upper and lower direction (Y axis direction) by adjusting any penetration extent of the bolt thread parts 53 of the second hanging part 11 to the speaker box 7. Since each of the elastic bodies 52 of the second hanging part 11 is a hemisphere shape as illustrated in FIG. 5, the speaker box 7 can be hung stably in a state that the speaker box 7 is inclined as illustrated in FIG. 4 (d).

Each of the above mentioned structures of the first hanging part 10 and the second hanging part 11 is not limited to a bolt shape as illustrated in FIG. 5. A structure that the speaker box can be hung so that the speaker box does not contact to the enclosure 2 may be suitable. Further, a structure that a vibration of the speaker box is hard to conduct to the enclosure 2 is more preferable as the elastic body 52.

A cross section which is parallel to Y-Z flat surface of each of the above mentioned the first enclosure 3 and the second enclosure 4 is a Japanese “Ko” character shape, for example (see FIG. 4 (d)). While a surface of a sound emitting side is a structure that the speaker box 7 is directly seen, a grill may be mounted on a surface of the sound emitting side as mentioned below. The Japanese “Ko” character shape enclosure 4 may be formed of a steel plate by a die processing, for example, and may be formed by an extrusion processing of an aluminum. Further, each of the first enclosure and the second enclosure may be a shape like a box in which a front surface is released. Further, the third enclosure 5 is also similar. Since there is no place to emit a sound, it is not necessary that it is the Japanese “Ko” character shape necessarily. For example, it may be a cylindrical structure in which a front surface is closed and that a cross section is a Japanese “Ro” character shape. For example, the first enclosure 3 and the third enclosure 5 may be fixed by providing an adjustment part on a rear surface (an opposite side surface of a sound emitting direction) of the enclosure 2. It is not needed to say that they may be fixed by providing the adjustment part on a top surface or a bottom surface of the enclosure 2. A cross section shape of the enclosure 2 can be appropriately selected.

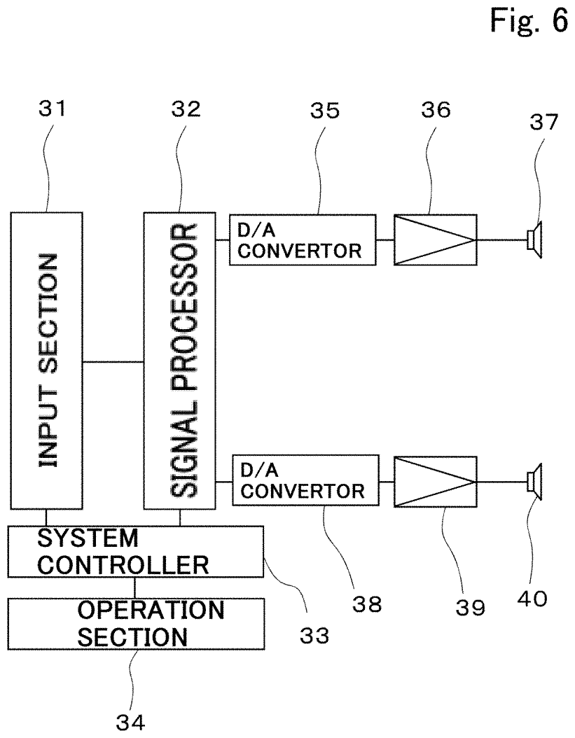

FIG. 6 is a block diagram illustrating a circuit configuration of the acoustic device 1 according to an embodiment of the present disclosure. The acoustic device 1 has two speakers (a first speaker unit 37 and a second speaker unit 40). They respectively correspond to a left channel and a right channel. Further, the acoustic device 1 has an input section 31 which inputs a reproduction signal of a sound source such as a recording medium or the like, a television signal and so on, a signal processing section 32 which decodes the signal which is obtained by the input section 31 and performs a signal processing to an acoustic signal of each channel, a D/A converter 35 and a D/A converter 38 which respectively convert a digital signal of each channel which is output by the signal processing section 32 into an analog signal, and an amplifier 36 and an amplifier 39.

Further, the acoustic device 1 has a system controller 33 which controls an entire of the acoustic device 1 and an operation section 34 which obtains input information of a user. Further, the acoustic device 1 has a power source (not shown) for driving them.

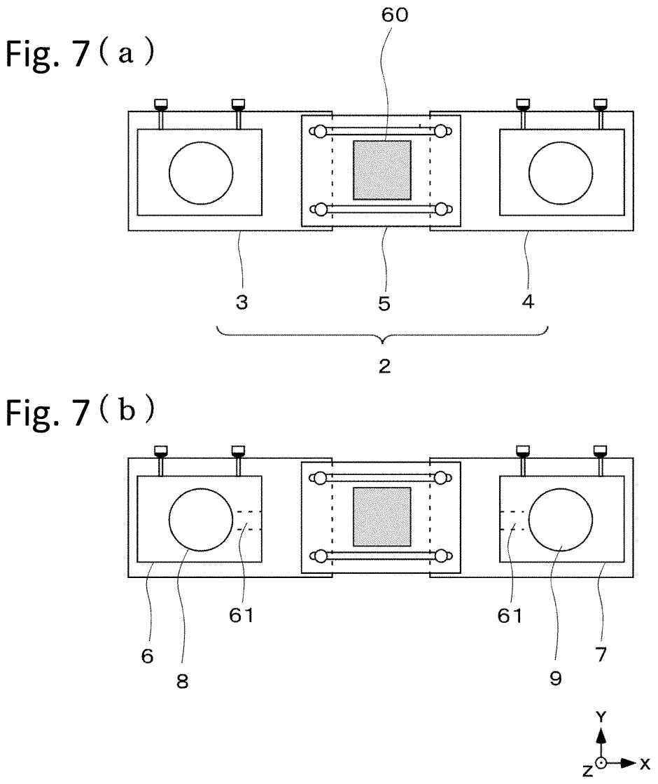

While various circuits and power supply which are illustrated in FIG. 6 may be arranged at an outside of the acoustic device 1, they can be arranged at an inside of the acoustic device 1. FIG. 7 (a) illustrates the acoustic device 1 that electronic equipment 60 corresponding to a circuit and a power supply which are illustrated in FIG. 6 is arranged at an inside of the enclosure 2. For example, a portable reproduction device, a smart speaker (a speaker which activates by sound-recognizing a predetermined wake word and responds against an audio command) or the like may be arranged at a space of an inside of the enclosure 2 of the acoustic device 1 in addition to this. Further, speaker boxes such as a center channel and a subwoofer may be arranged. For example, a speaker box of a surround channel may be arranged.

Since the above mentioned electronic equipment 60 and so on generates heat, a heat radiation hole (not shown) is provided at the enclosure 2 to enable to be cooled. When a cooling of the electronic equipment 60 is not enough by only natural ventilation by the heat radiation hole, an air movement by bass reflex ports 61 of the first speaker box 6 and the second speaker box 7 can be also used. FIG. 7 (b) illustrates directions of the bass reflex ports 61 the first speaker box 6 and the second speaker box 7. The bass reflex ports 61 direct to a direction of an inside of the enclosure 2 that the electronic equipment 60 is arranged. When a sound is reproduced, an air of the speaker box inside goes in and out via the bass reflex ports 61. The electronic equipment 60 can be cooled by this air movement more efficiently. Further, a reproduction performance of low sound band can be also improved by directing the bass reflex ports 61 to the enclosure 2 inside of the acoustic device 1 and using the enclosure 2 as a further speaker box.

While two bass reflex ports 61 illustrated in FIG. 7 face with each other, they may be arranged not to be faced with each other in Y axis direction. Since flow of an air which occurs at two bass reflex ports 61 is hard to directly collide due to this, the electronic equipment 60 can be cooled more efficiently. Further, when cooling of the electronic equipment 60 is treated more seriously, the bass reflex ports 61 can be set near to the electronic equipment 60 by shortening a size of X axis direction of the enclosure 2.

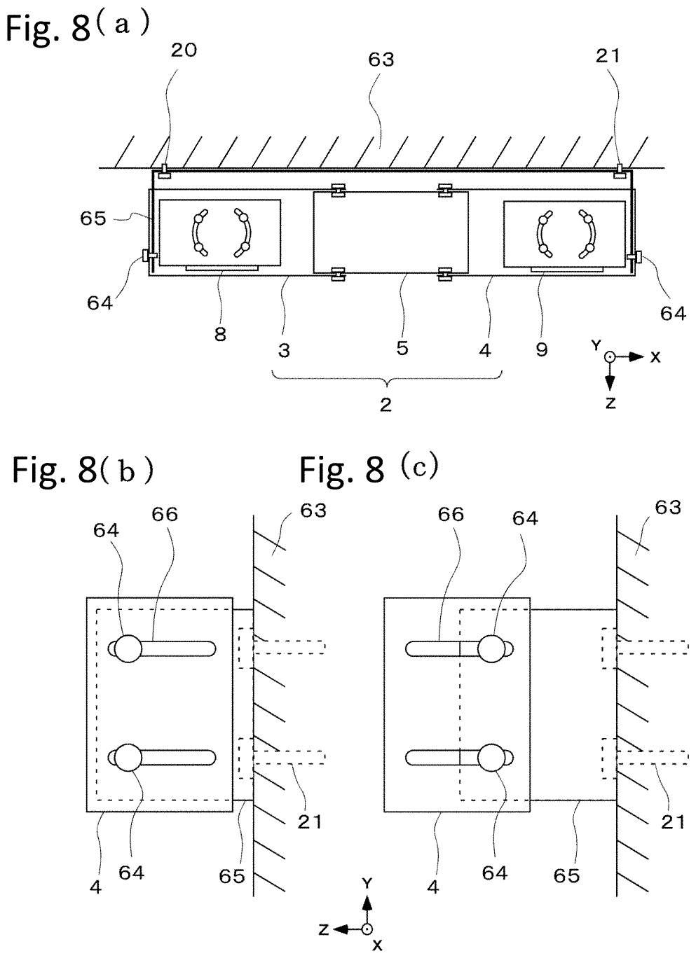

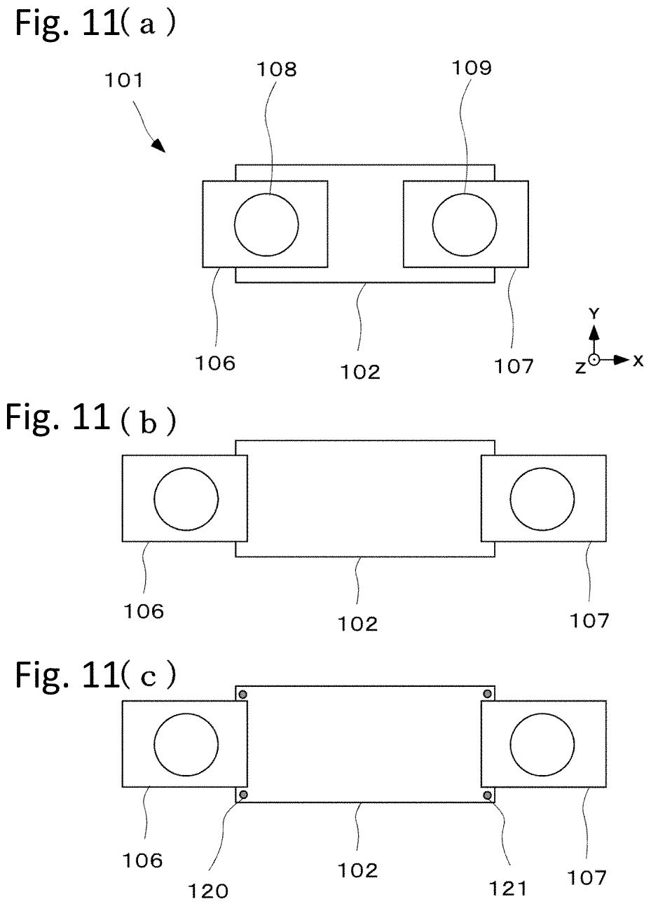

FIG. 8 is a diagram that the acoustic device 1 is fixed to a wall surface 63 by using a wall surface fixing tool 65 (a diagram which is seen from a positive direction to a negative direction of Y axis). The wall surface fixing tool 65 is a Japanese “Ko” character shape when being seen from Y axis direction. The wall surface fixing tool 65 is fixed to the wall surface 63 by a wall surface fixing screw 20 and a wall surface fixing screw 21. An edge surface of the longitudinal direction of the enclosure 2 of the acoustic device 1 is fixed to the wall surface fixing tool 65 by side surface fixing screws 64. Since the edge part of the conventional acoustic device 101 illustrated in FIG. 11 is the speaker box, the acoustic device 101 only has a choice to be fixed by an edge surface of the enclosure 102 when using a wall surface fixing tool. On the other hand, since the edge part of the longitudinal direction of the acoustic device 1 is not the speaker box and the enclosure 2, the acoustic device 1 can be fixed by the edge part of the acoustic device 1 as illustrated in FIG. 8. Due to this, the acoustic device 1 can be fixed to the wall surface 63 stably.

Further, a position of the acoustic device 1 can be adjusted to a front and a rear (Z axis direction) against the wall surface by setting holes of the edge part of the acoustic device 1 to insert the side surface fixing screws 64 to long holes (side surface long holes 66) as illustrated in FIGS. 8 (b) and (c). Since the edge surface of the acoustic device 101 cannot be fixed to the wall surface fixing tool in the conventional acoustic device 101 which is illustrated in FIG. 11, a wall surface fixing tool of a pantograph shape complicated mechanism is used in a rear surface of the enclosure 102 so as to perform a position adjustment to a front and a rear direction. The position of Z axis direction of the acoustic device 1 of the present disclosure can be adjusted by a simple structure as illustrated in FIG. 8 (b) and (c). Due to this, it becomes easy to match a surface of a sound emitting side of the acoustic device 1 to a television screen and an appearance can be improved.

### (Variation 1)

Since the enclosure 2 of the acoustic device 1 has a mechanism which adjusts the length of the longitudinal direction, there is a case where a user is easy to view a seam of the enclosure 2. For this reason, a grill may be mounted on a sound emitting side surface of the enclosure 2. The grill may have a mechanism which can adjust a length of a longitudinal direction and further, the length may be adjusted by assembling parts in which a length is different. Further, since a width of a main television is limited to several types, the grills which match each width may be prepared, selected, and used. Further, a decorative plate or the like may be appropriately mounted on the other surface of the enclosure 2 of the acoustic device 1.

### (Variation 2)

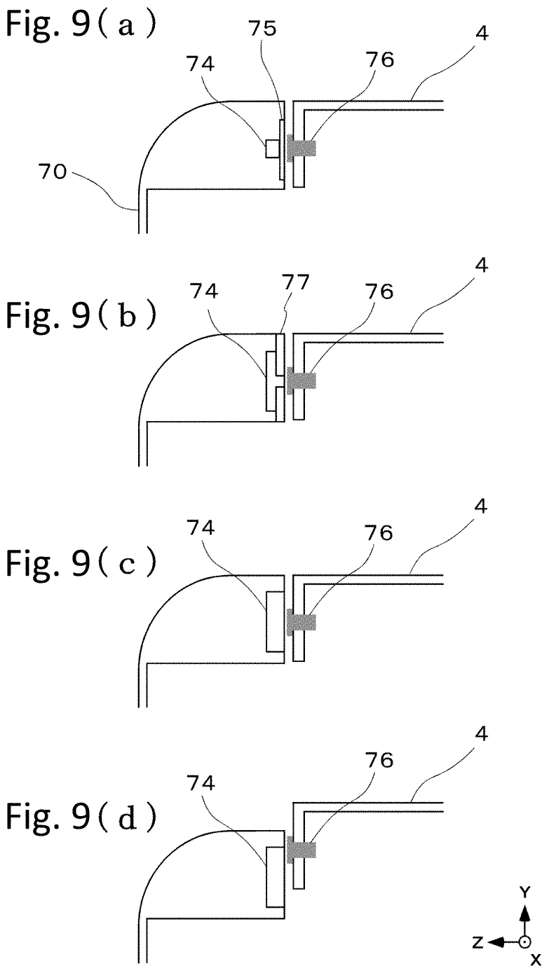

FIG. 9 is a cross section of the acoustic device 1 in Y-Z flat surface and illustrates a structure of a part which mounts a grill 70 to the enclosure 2. For a timing that the electronic equipment 60 or the like is arranged in the enclosure 2 and a user who would like to remove the grill 70 and use, the grill 70 may be fixed to the enclosure 2 by a magnet so as to enable to be easily mounted and removed. When the second enclosure 4 is formed of a material such as an aluminum or the like, an iron piece 76 which attaches to the magnet, for example, a screw head part or the like is arranged at the second enclosure 4. A magnet 74 is arranged at the grill 70.

When using the magnet 74 which is larger than the iron piece 76 as illustrated in FIG. 9 (c), since magnetic flux density of a peripheral part is high in the magnet 74, the iron piece 76 attaches to the magnet 74 without matching a center of the magnet 74 as illustrated in FIG. 9(d). For this reason, while it is preferable that the magnet 74 is the same extent size as the iron piece 76, a margin of a position adjustment between the enclosure 2 of the acoustic device 1 and the grill 70 becomes small. When the enclosure 2 is expandable as the acoustic device 1 of the present disclosure, difference in a size between the enclosure 2 and the grill 70 is easy to occur. When the margin of the position adjustment of the grill 70 is small, there is a possibility that the grill 70 cannot be slightly adjusted to a right position and fixed. Further, there is also a method to set the iron piece 76 to larger than the magnet 74. However, when a head part of a screw is used as the iron piece 76, a large screw must be used. It is generally difficult to make a screw in which a head part is large. Further, when the grill 70 is removed and used, it is possible that an appearance is spoiled.

As illustrated in FIG. 9(a), when an iron plate 75 in which a diameter is larger than the magnet 74 is arranged at the magnet 74, the iron piece 76 can be attached to anywhere of the iron plate 75. It becomes easy to adjust a mounting position of the grill 70.

Further, as illustrated in FIG. 9(b), the magnet 74 may be configured to be a convex type, a resin washer 77 may fitted into the magnet 74, the magnet may be mounted on the grill 70. Thus, since a magnetic flux density in a position of the iron piece 76 of the magnet 74 becomes to almost uniform, it becomes easy to adjust the mounting position of the grill 70 similarly.

### (Variation 3)

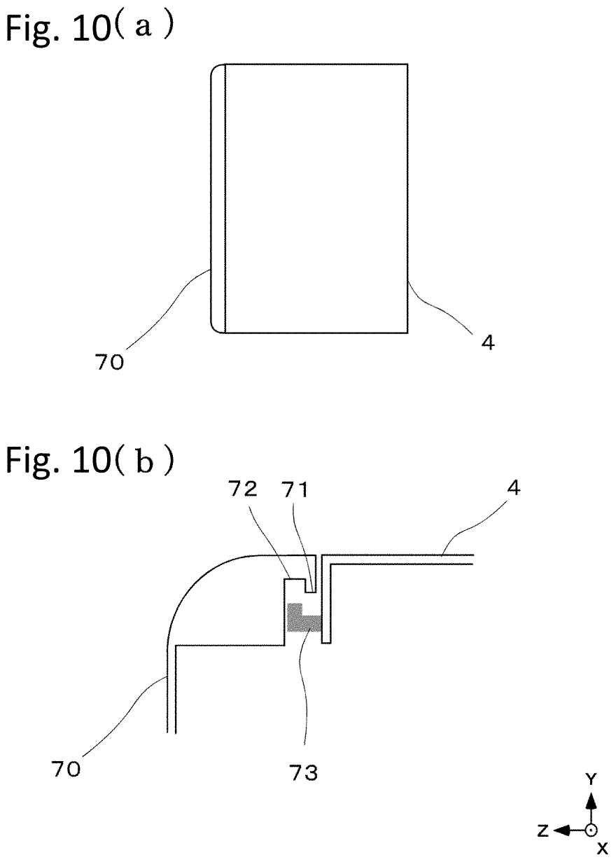

FIG. 10 (a) is a diagram that the acoustic device 1 is seen from a positive direction to a negative direction of X axis (in the present diagram, a position adjustment function of Z axis direction in FIG. 8 (b) is omitted). As mentioned above, the grill 70 is fixed to the second enclosure 4 by the magnet 74. While the magnet 74 is for mounting and removing the grill 70 easily, there is a possibility that the grill 70 drops when a large earthquake occurs or a user collides with the grill 70. Thus, as illustrated in FIG. 10(b), a hook 73 may be provided at the second enclosure 4. As mentioned above, since the grill 70 is fixed by the magnet 74 and the iron piece 75, the hook 73 does not perform a fixing function of the grill 70 during a general use. However, when the grill 70 is removed by an earthquake or the like, the hook 73 hooks to a concave part 72 of the grill 70 and it is possible to prevent dropping of the grill 70.

### (Variation 4)

A mechanism to adjust a size of an upper and a lower direction of the enclosure 2 may be provided by dividing the above mentioned enclosure 2 (the first enclosure 3, the second enclosure 4, and the third enclosure 5) to the upper and the lower direction (Y axis direction) and adding an extension metal fitting between them. Further, the first enclosure 3 and the second enclosure 4 which are divided to the upper and the lower direction may be fixed to the third enclosure 5 in which a length of Y axis direction is long. By being able to adjust the sized of the upper and the lower direction of the enclosure 2, the speaker box in which a size of Y axis direction is larger can be arranged at an inside. Further, the electronic equipment 60 in which a size of Y axis direction is lager can be also arranged.

As described above, in the present embodiment, an acoustic device has a first speaker box that a first speaker unit is arranged, a second speaker box that a second speaker unit is arranged, an enclosure that the first speaker box and the second speaker box are arranged at an inside, and the enclosure has an adjustment part which adjusts an interval between the first speaker box and the second speaker box. Thus, the acoustic device which can adjust the interval between two speaker boxes can be provided.

Further, in the present embodiment, the enclosure has a fixing part which is for fixing the acoustic device to a wall surface. Thus, the acoustic device can be fixed to the wall surface stably.

Further, in the present embodiment, the enclosure has a first enclosure that the first speaker box is arranged at an inside, a second enclosure that the second speaker box is arranged at an inside, and a third enclosure intervenes between the first enclosure and the second enclosure. Thus, the enclosure of the acoustic device which can adjust the interval between two speaker boxes can be provided.

Further, in the present embodiment, the acoustic device has a first hanging part which hangs the first speaker box at an inside of the enclosure and a second hanging part which hangs the second speaker box at an inside of the enclosure. Thus, a vibration of the speaker box becomes hard to conduct to the enclosure. When the acoustic device is fixed to the wall surface, the vibration of the speaker box becomes hard to conduct to the wall surface. For this reason, a noise by the unnecessary vibration of the wall surface can be reduced. Further, a sound quality of a sound which is emitted from the speaker box becomes hard to be influenced by the enclosure and the wall surface.

Further, in the present embodiment, the first hanging part and the second hanging part respectively hang the first speaker box and the second speaker box by bolts which are inserted into openings which are provided at the enclosure, an elastic body intervenes between a head part of the bolt and the enclosure. Thus, the acoustic device that the vibration of the speaker box is harder to conduct to the enclosure can be provided. Further, with regard to the sound emitting direction of the speaker box, an adjustment of an angle in an upper and a lower direction can be performed.

Further, in the present embodiment, the opening is an arc shape long hole, and the sound emitting direction of the first speaker unit and the second speaker unit can be adjusted against the enclosure. Thus, the acoustic device which can adjust the sound emitting direction of the speaker in a left and a right can be provided. When also changing a length of the acoustic device, the sound emitting direction of the speaker can be adjusted to a suitable direction.

Further, in the present embodiment, a grill corresponding to an outer shape of the acoustic device is arranged at a surface of a sound emitting side of the acoustic device. Thus, the acoustic device in which an appearance which is seen from a sound emitting side is good even though adjusting an outer size of the acoustic device can be provided.

Further, in the present embodiment, the first speaker box and the second speaker box respectively have bass reflex ports and the sound emitting direction of each of the bass reflex ports directs to an inside of the enclosure. Thus, since the enclosure can be functioned as a larger speaker box, the acoustic device in which low sound reproduction ability is improved can be provided.

Further, in the present embodiment, the acoustic device has a place that equipment which has a characteristics which generates heat during the acoustic device operation is arranged in an inside of the enclosure which is sandwiched by a sound emitting port of the bass reflex port of the first speaker box and a sound emitting port of the bass reflex port of the second speaker box. Thus, the acoustic device which can cool the equipment which has the characteristics which generates heat such as an amplifier, a power supply, a smart speaker or the like which is arranged within the acoustic device by a movement of an air which is formed by the bass reflex ports can be provided.

Further, in the present embodiment, the acoustic device has a wall surface fixing tool which fixes the acoustic device to a wall surface, and the wall surface fixing tool supports an edge surface of a longitudinal direction of the acoustic device. Thus, the acoustic device can be fixed to the wall surface stably.

Further, in the present embodiment, an acoustic device has a first speaker box that a first speaker unit is arranged, a second speaker box that a second speaker unit is arranged, and an enclosure that the first speaker box and the second speaker box are arranged at an inside, and an interval between the first speaker box and the second speaker box is variable. Thus, the acoustic device which can adjust the interval between two speaker boxes can be provided.

Further, in the present embodiment, the enclosure has the first enclosure that the first speaker box is arranged at an inside, the second enclosure that the second speaker box is arranged at an inside, and the third enclosure which intervenes between the first enclosure and the second enclosure, and the third enclosure has a linear shape long hole, the first enclosure and the second enclosure are connected to the third enclosure by screws which are inserted into the linear shape long hole. Thus, the acoustic device which can adjust the interval between two speaker boxes can be provided.

The present disclosure is not limited to the above mentioned embodiment, can appropriately be changed within a range which is not against an abstract or an idea the disclosure which is read from an entire of the scope of the claims and the description, and the acoustic device with such the change is also included in a technical range of the disclosure.

The present disclosure can be suitably employed in an acoustic device.

What is claimed is:

1. An acoustic device comprising:
a first speaker box that a first speaker unit is arranged;
a second speaker box that a second speaker unit is arranged; and
an enclosure that the first speaker box and the second speaker box are arranged at an inside,
wherein the enclosure has an adjustment part which adjust an interval between the first speaker box and the second speaker box.

2. The acoustic device according to claim 1,
wherein the enclosure has a fixing part which is for fixing the acoustic device to a wall surface.

3. The acoustic device according to claim 1,
wherein the enclosure has
a first enclosure that the first speaker box is arranged at an inside,
a second enclosure that the second speaker box is arranged at an inside, and
a third enclosure which intervenes between the first enclosure and the second enclosure.

4. The acoustic device according to claim 1 comprising:
a first hanging part which hangs the first speaker box at an inside of the enclosure; and
a second hanging part with hangs the second speaker box at an inside of the enclosure.

5. The acoustic device according to claim 4,
wherein the first hanging part and the second hanging part respectively hang the first speaker box and the second speaker box by bolts which are inserted into openings which are provided at the enclosure, and
an elastic body intervenes between a head part of the bolt and the enclosure.

6. The acoustic device according to claim 5,
wherein the opening is an arc shape long hole, and
a sound emitting direction of the first speaker unit and the second speaker unit can be adjusted against the enclosure.

7. The acoustic device according to claim 1,
wherein a grill corresponding to an outer shape of the acoustic device is arranged at a surface of an sound emitting side of the acoustic device.

8. The acoustic device according to claim 1,
wherein the first speaker box and the second speaker box respectively have bass reflex ports, and
a sound emitting direction of each of the bass reflex ports directs to an inside of the enclosure.

9. The acoustic device according to claim 8 having a place that equipment which has a characteristics of generating heat during the acoustic device operation at an inside of the enclosure which is sandwiched by a sound emitting port of the bass reflex port of the first speaker box and a sound emitting port of the bass reflex port of the second speaker box.

10. The acoustic device according to claim 1 comprising:
a wall surface fixing tool which fixes the acoustic device to a wall surface,
wherein the wall surface fixing tool supports an edge surface of a longitudinal direction of the acoustic device.

11. An acoustic device comprising:
a first speaker box that a first speaker unit is arranged;
a second speaker box that a second speaker unit is arranged; and
an enclosure that the first speaker box and the second speaker box are arranged at an inside,
wherein an interval between the first speaker box and the second speaker box is variable in the enclosure.

12. The acoustic device according to claim 11,
wherein the enclosure has
a first enclosure that the first speaker box is arranged at an inside,
a second enclosure that the second speaker box is arranged at an inside, and
a third enclosure which intervenes between the first enclosure and the second enclosure, and
the third enclosure has a linear shape long hole, and
the first enclosure and the second enclosure is connected to the third enclosure by screws which are inserted into the linear shape long hole.
